(19) United States
(12) Patent Application Publication
(10) Pub. No.: US 2026/0264460 A1
(43) Pub. Date: Sep. 10, 2026

(54) TIRE IDENTIFICATION GATE AND METHOD FOR LONG MULTI-WHEELED MOTOR VEHICLES SUCH AS TRUCKS, SEMITRUCKS, ROAD TRAINS, BUSES OR THE LIKE

(71) Applicant: BRIDGESTONE EUROPE NV/SA, Zaventem (BE)

(72) Inventors: Maria Cristina CACCAMI, Roma (IT); Alessandro BOLDRINI, Roma (IT); Lorenzo ALLEVA, Roma (IT); Cecilia OCCHIUZZI, Roma (IT); Sara AMENDOLA, Roma (IT); Nicola D'UVA, Roma (IT); Giorgio PICCARDO, Roma (IT); Alessio MOSTACCIO, Roma (IT); Gaetano MARROCCO, Roma (IT)

(21) Appl. No.: 19/163,727

(22) PCT Filed: Mar. 7, 2024
(86) PCT No.: PCT/IB2024/052196

§ 371 Date: Sep. 9, 2025

(30) Foreign Application Priority Data
Mar. 9, 2023 (EP) 23161025.4

(51) Int. Cl. B60C 23/04

(52) U.S. Cl. CPC B60C 23/0416; B60C 23/0479

(57) ABSTRACT

A computer-implemented method for efficiently identifying tire configuration of motor vehicles having tires fitted, each, with a respective wireless identification device. The method comprises: receiving identification data indicative of the unique identifiers of the tires positioned on a left side of a given motor vehicle of said motor vehicles; receiving identification data indicative of the unique identifiers of the tires positioned on the right side of the given motor vehicle; grouping the received identification data into a left-side data group and a right-side data group; sorting the identification data in the left-side group and the identification data in the right-side group according to time order of acquisition; for either the left-side group or the right-side group: iteratively applying a K-means clustering method to the sorted identification data thereby obtaining, at each iteration, a respective identification data clustering representing a respective candidate tire configuration of the given motor vehicle.

### TECHNICAL FIELD

The present invention relates, in general, to identification of tires of motor vehicles, in particular of long multi-wheeled motor vehicles such as trucks, semitrucks, road trains, buses or the like. More specifically, the present invention concerns a tire identification system and a related tire identification method whose use is particularly advantageous with long multi-wheeled motor vehicles fitted with dual-type wheels.

### STATE OF THE ART

As is known, radiofrequency identification (RFID) technology is widely used in the automotive sector for identification and monitoring aims. In particular, nowadays the integration of RFID devices into/on tires for tire identification and monitoring purposes is widespread in order to:
optimize production processes, logistics and Original Equipment Manufacturer (OEM) mounting lines operations;
ensure tire tracking and traceability;
improve operational efficiency in fleet management (e.g. maintenance operations);
speed up stock control and audit with more data accuracy; and
enable services for mobility solutions.

For example, EP 3 074 917 A1 discloses a system for the dynamic reading of data from a vehicle tire transponder having a linearly polarized antenna, said system comprising at least one antenna that can receive data transmitted by the transponder and at least one reader coupled to the antenna and capable of reading and storing the data from the transponder, in which the antenna is a linearly polarized antenna with a vertical electric field.

EP 2 829 659 A1 discloses a stand and antenna assembly for receiving a data transmission from an electronic transmitting device mounted to a vehicle. The vehicle has at least one tire assembly including a tire. The stand and antenna assembly comprises a stand having an upper surface or a substantially convex upper surface, the upper surface comprising a lead-on ramped surface and an exit-off ramped surface aligned and operative to intercept and engage the tire as the tire traverses over the upper surface of the stand. The stand further comprises a base having at least one pocket disposed therein and configured for receiving an antenna assembly, and at least a first antenna assembly within the one pocket of the base. The antenna assembly is seated at a tilt angle with respect to a bottom plane of the base within the pocket and is operative to direct a read field toward a vehicle approach path to the stand.

U.S. Pat. No. 10,935,466 B2 discloses an integrated tire sensor and reader system including at least one sensor unit mounted a tire or a wheel. A reader is disposed remotely from the sensor unit. The sensor unit includes at least one sensor for measuring a parameter of the tire or wheel and an antenna for communicating with the reader. The sensor unit is configured to receive a radio frequency power signal from the reader and to transmit data to the reader. The reader includes an antenna for transmitting the radio frequency power signal to the sensor unit to actuate the one sensor unit. Upon actuation of the sensor unit, the sensor measures the parameter of the tire or wheel, and data from the sensor is transmitted from the sensor unit to the reader.

U.S. Pat. No. 8,009,027 B2 discloses a tire monitoring system and associated method. The tire monitoring system includes a plurality of tire sensor modules, employing contactless sensors, configured to transmit tire data at a predetermined time interval. The system also includes a central control unit that is configured to receive the tire data from the tire sensor modules, and is further configured with an external control unit that can communicate with the tire sensor modules, the central control units and outside sources.

In this context, it is worth noting that tire identification can become a very hard task in case of trucks, semitrucks, road trains, buses and, more in general, long multi-wheeled motor vehicles due to the close presence of many wheels, often of the dual type. In fact, in these cases, identification data from some tires can be lost, or can be affected by so much noise that they are unusable, or can be wrongly associated with, or confused/combined with data from, other tires, or the like. Therefore, in these scenarios, tire identification performance is noticeably degraded thereby influencing also performance of any other monitoring task performed in combination with, and based on, tire identification (e.g., tire pressure monitoring, tread wear monitoring, etc.).

Thence, nowadays there is a strong need for an efficient tire identification technology in the automotive sector, especially in all those cases where known tire identification technologies are unreliable and inefficient, for example in the case of trucks, semitrucks, road trains, buses and, more in general, long multi-wheeled motor vehicles fitted with dual-type wheels.

### OBJECT AND SUMMARY OF THE INVENTION

In view of the foregoing, the Applicant has felt the need to develop an efficient tire identification technology allowing to efficiently identify tires of motor vehicles, such as long multi-wheeled motor vehicles fitted with dual-type wheels (e.g. trucks, semitrucks, road trains, buses or the like), thereby conceiving the present invention.

Thence, an object of the present invention is that of providing a tire identification technology that, in general, overcomes the technical drawbacks of prior art solutions and, more specifically, provides efficient tire identification of motor vehicles, such as long multi-wheeled motor vehicles fitted with dual-type wheels, trucks, semitrucks, road trains, buses or the like.

This and other objects are achieved by the present invention in that it relates to a computer-implemented method for efficiently identifying tire configuration of motor vehicles, and a related tire identification gate and method, as defined in the attached claims.

In particular, the present invention concerns a computer-implemented method for efficiently identifying tire configuration of motor vehicles having tires fitted, each, with a respective wireless identification device, the method comprising:
receiving identification data indicative of the unique identifiers of the tires positioned on a left side of a given motor vehicle of said motor vehicles;
receiving identification data indicative of the unique identifiers of the tires positioned on the right side of the given motor vehicle;
grouping the received identification data in a left-side data group and a right-side data group;
sorting the identification data in the left-side group and the identification data in the right-side group according to time order of acquisition;
for either the left-side group or the right-side group:
   iteratively applying a K-means clustering method to the sorted identification data thereby obtaining, at each iteration, a respective identification data clustering representing a respective candidate tire configuration of the given motor vehicle;
   5-evaluating the obtained identification data clusterings by a Davies-Bouldin Index metric thereby determining an estimated tire configuration of the given motor vehicle;
   determining an actual tire configuration of the given motor vehicle by evaluating the estimated tire configuration by an Edit Distance metric;
determining a respective position, in the determined actual tire configuration, of each tire on the side associated to the determined group and assigning to said position the respective unique identifier based on said determined actual tire configuration and on the sorted identification data;
determining a respective position, in the determined actual tire configuration, of each tire on the opposite side of the given motor vehicle and assigning to said position the respective unique identifier based on said determined actual tire configuration and on the sorted identification data.

### BRIEF DESCRIPTION OF THE DRAWINGS

For the understanding of the present invention, embodiments thereof will be described hereinafter, purely as non-limitative, non-binding examples, with reference to the enclosed drawings, wherein:

FIG. 1 schematically illustrates a high-level functional architecture of an RFID gate for motor vehicles such as trucks or the like according to an embodiment of the present invention;

FIG. 2 shows an exemplary implementation of the RFID gate of FIG. 1;

FIG. 3 shows a schematic bottom view of the semitruck of FIG. 2;

FIG. 4 schematically illustrates a tire identification method according to an embodiment of the present invention; and

FIGS. 5-9 show examples of results obtainable by performing some steps of the tire identification method as exemplified in FIG. 4.

### DESCRIPTION OF EMBODIMENTS OF THE INVENTION

Hereinafter the present invention will be described in detail also with reference to the drawings, to allow a person skilled in the art to comprehend, reproduce and use it. Various modifications to the described embodiments will be immediately apparent to the person skilled in the art and the generic principles described can be applied to other embodiments and applications without departing from the protective scope of the present invention, as defined in the attached claims. Therefore, the present invention should not be considered limited to the described and illustrated embodiments, but it must be accorded the widest protective scope in accordance with the described and claimed characteristics.

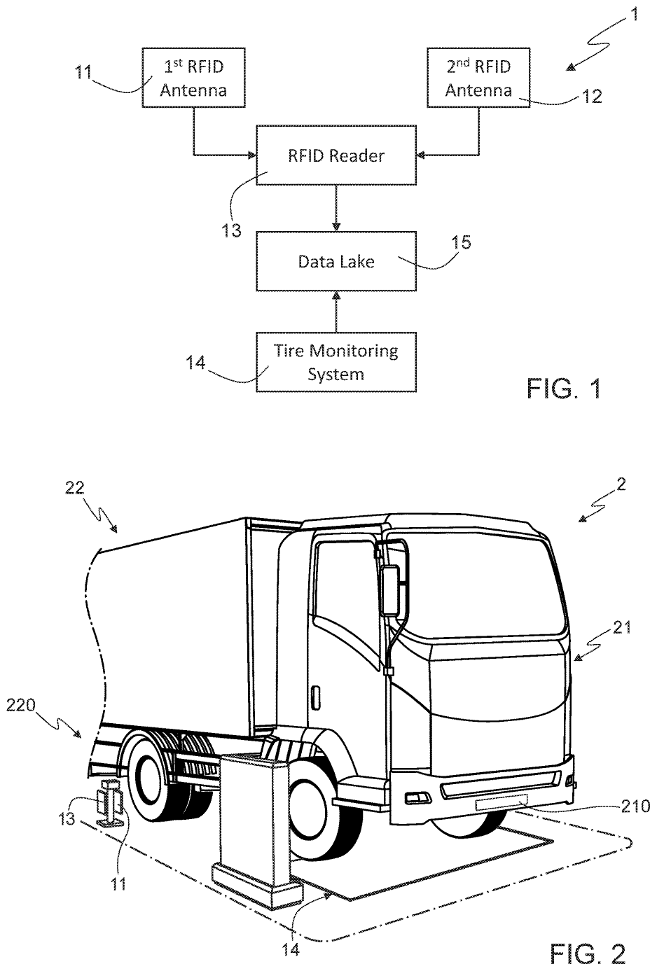

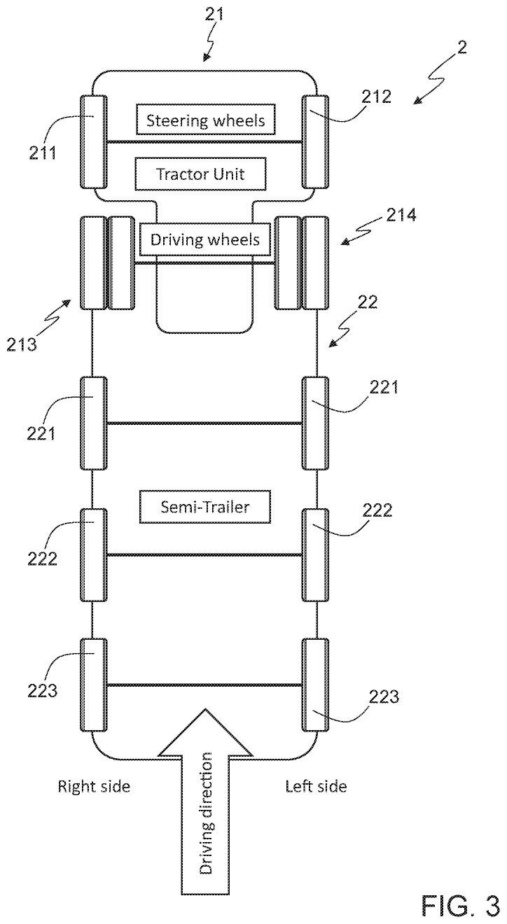

FIG. 1 schematically illustrates a high-level functional architecture of an RFID gate (denoted as a whole by 1) for motor vehicles such as trucks or the like (e.g. semitrucks, road trains, buses or, more in general, long multi-wheeled motor vehicles) according to an embodiment of the present invention, while FIG. 2 shows an examplary implementation of the RFID gate 1.

In particular, said RFID gate 1 is designed to be driven through by motor vehicles, such as trucks (e.g. the semitruck shown in FIG. 2 and denoted as a whole by 2 therein) and comprises a pair of RFID antennas 11, 12 arranged on opposite sides of a path to be driven by the trucks. In this respect, it is worth noting that, in FIG. 2, only the right-side RFID antenna 11 (right-side by referring to the driving direction of the semitruck 2) is shown, whereas the left-side RFID antenna 12 is not visible.

Additionally, the RFID gate 1 further includes an RFID reader 13 and a tire monitoring system 14 that is configured, while the semitruck 2 is driving through the RFID gate 1, to monitor one or more tire features, and that, in the example in FIG. 2, is implemented by means of a ramp designed to determine tire tread wear (e.g., via laser measurements) of truck's tires rolling thereon.

The semitruck 2 includes a tractor unit 21 and a semi-trailer 22 attached to, and pulled by, the tractor unit 21. The tractor unit 21 is conveniently fitted with a respective RFID tag storing respective identification data indicative of a respective Unique Identifier (UID) of said tractor unit 21: in an exemplary embodiment, said RFID tag might be conveniently mounted/installed on or near a front plate 210 of the tractor unit 21 to be easily readable by the RFID antennas 11, 12. Also the semi-trailer 22 is conveniently fitted with a respective RFID tag storing respective identification data indicative of a respective UID of said semi-trailer 22: in an exemplary embodiment, said RFID tag might be conveniently mounted/installed on a lower part 220 of the semi-trailer 22 to be easily readable by the RFID antennas 11, 12. Moreover, each tire of the semitruck 2 (i.e., of the tractor unit 21 and of the semi-trailer 22) is fitted with a respective RFID tag storing respective identification data indicative of a respective UID of said tire.

In this respect, FIG. 3 shows a schematic bottom view of the semitruck 2 and it is worth noting that:
the tractor unit 21 is fitted with a front pair of steering wheels 211, 212 and with two rear pairs of dual driving wheels 213, 214; and
the semi-trailer 22 is fitted with three pairs of trailer wheels 221, 222, 223.

The RFID antennas 11, 12 are configured, while the semitruck 2 is driving through the RFID gate 1, to interrogate the RFID tags of:
the tractor unit 21,
the tires of the steering wheels 211, 212 and of the driving wheels 213, 214,
the semi-trailer 22 and
the tires of the trailer wheels 221, 222, 223, to read therefrom the respective identification data carried by the UIDs.

The RFID antennas 11, 12 are further configured to provide the RFID reader 13 with the read identification data. The RFID reader 13 is a processing device comprising at least one processor and a memory. It can be installed close to the RFID antennas 11, 12, and can be connected thereto in a wired fashion. Otherwise, the RFID reader 13 can be a remote device/system remotely connected to the RFID antennas 11, 12 in a wired and/or wireless manner. In an exemplary embodiment, the RFID reader may be implemented in a cloud computing system at a site that is remote from the RFID gate 1.

The RFID reader 13 is configured to identify and locate the mounting position of each tire of the semitruck 2 with respect to the latter (i.e. determine a respective tire position referenced to said semitruck 2) based on the read identification data received from the RFID antennas 11, 12.

Then, the respective UID and position of each identified, located tire may be stored in a data lake 15 in association with the respective tire monitoring data provided by the monitoring system 14.

In order to identify and locate each tire of the semitruck 2, the RFID reader 13 is programmed to carry out a predefined tire identification method including two main phases, namely a clustering phase and a sequencing phase.

In fact, generally speaking with respect to motor vehicles classifiable as trucks, the actual position of each tire of a truck, and thus its type, is strictly dependent on the truck configuration (more specifically, the tire/wheel configuration/layout of the truck considered). Therefore, it is necessary to distinguish tire clusters, if any, to determine the tire configuration of the truck. Namely, clusters represent tire groups according to the type of truck considered (e.g. tires of steering, driving or trailer wheels). In most cases, each cluster contains more than one tire; hence, a strategy to determine cluster hierarchy is required (sequencing phase).

The predefined tire identification method carried out by the RFID reader 13 focuses on each of the obtained clusters of tires rather than on all the tires of the motor vehicle considered as a whole. In this way, read errors are not propagated over the entire system, but can be treated efficiently within the single cluster in a faster and more accurate way.

More in detail, the predefined tire identification method includes, as previously explained, two main phases: a clustering phase wherein the groups of axles are identified and then a sequencing phase wherein the positions of the tires within the determined tire configuration are identified. In addition, the method can conveniently include some additional specific steps to further improve accuracy (such as twin tire recognition).

It is worth noting that the predefined tire identification method is agnostic of the manner in which the identification data is acquired by the reader: it allows to determine the tire configuration of a motor vehicle (such as a truck) by using only readings of the tire-embedded RFID tags of the tires of the vehicle; that is, the method is applicable also in the absence of any specific RFID tags applied/installed on the vehicle itself (e.g. those identifying the tractor unit 21 and semi-trailer unit 22 of the semitruck 2), and even independently from the specific RFID gate architecture used as long as a suitable reader acquires the read identification data.

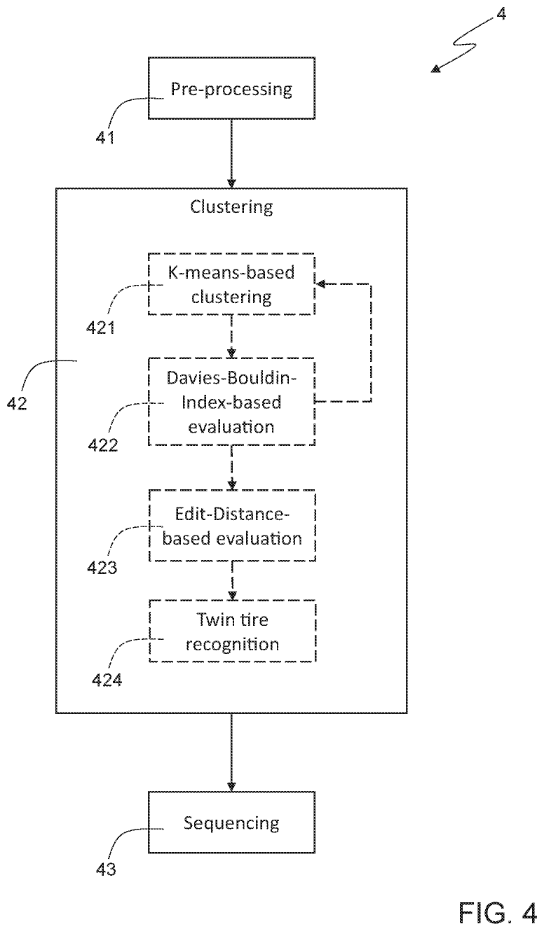

For a better comprehension of the present invention, FIG. 4 schematically illustrates a tire identification method (denoted as a whole by 4) that is carried out, in use, by the RFID reader 13 according to an embodiment of the present invention.

As shown in FIG. 4, the tire identification method 4 includes a pre-processing step 41 followed by said clustering and sequencing phases (denoted by 42 and 43, respectively).

Hereinafter the tire identification method 4 will be described in detail with reference to a semitruck like that of FIG. 2. However, it will be apparent to the person skilled in the art, in the light of the present disclosure, that the method is likewise applicable to any type of motor vehicle fitted with wheels.

### 1. Pre-Processing

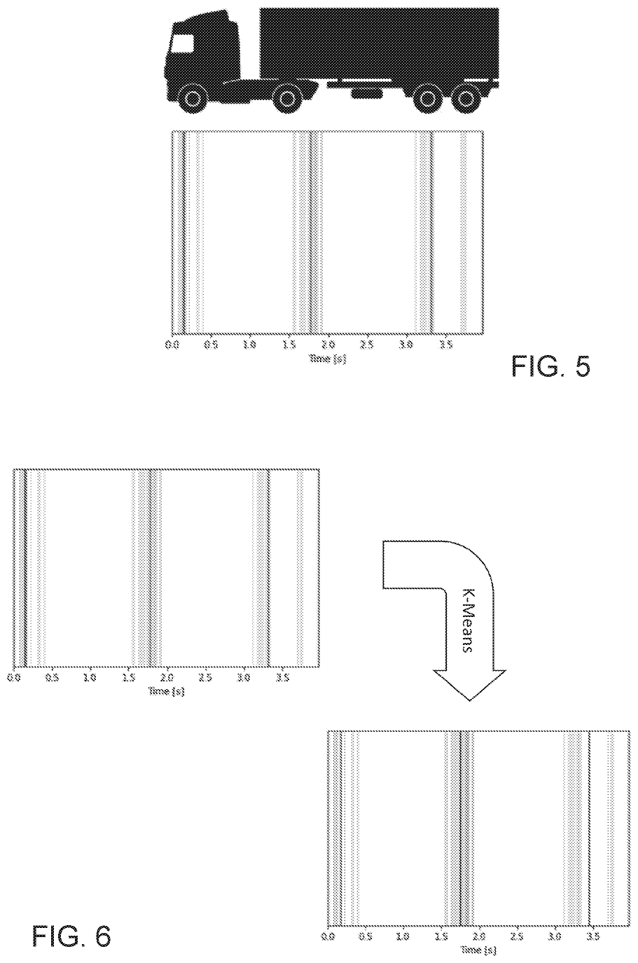

The clustering phase 42 is based on the idea of clustering the read identification data (i.e. the UIDs) according to their “collection” over time by the RFID antennas 11, 12. Accordingly, the pre-processing step 41 includes sorting the read identification data received from the RFID antennas 11, 12 according to time order of reading, as schematically illustrated in FIG. 5. Moreover, in order to render the algorithm more robust, the read identification data are separated, at this stage, in two groups according to which RFID antenna 11, 12 has provided said identification data, and thus according to the truck's side which the read identification data are related to.

### 2. Clustering

Once the pre-processing step 41 is terminated, the clustering phase 42 is carried out.

The separation in two data groups (left-side and right-side groups) during the pre-processing phase allows the algorithm to be more robust to missing readings. In fact, it may happen that an RFID tag is not read during the collection phase. In order to overcome this drawback, the clustering phase 42 is conveniently applied, first, to the group (associated to the corresponding truck's side) containing the highest number of read RFID tags.

More in detail, the clustering phase 42 includes:
a K-means-based clustering step 421 wherein an initial clustering is accomplished that represents an initial estimated tire configuration of the truck;
a Davies-Bouldin-Index-based evaluation 422, wherein the K-means-based clustering step 421 is iterated: the quality of the clusters obtained at each iteration of the K-means-based clustering step 421 is evaluated by a Davies-Bouldin Index metric to select the best clusters and, hence, the best tire configuration of the truck;
an Edit-Distance-based evaluation step 423 for determining the actual tire configuration of the truck based on an Edit Distance metric and a given dictionary of predefined tire configurations; and
an optional twin tire recognition step 424 for detecting twin tires of dual-type wheels.

### 2.1 K-Means

In the K-means-based clustering step 421 a K-means method is performed, whose inputs are the read identification data (conveniently, according to median reading timestamps associated/assigned with/to said read identification data) and an expected number of clusters.

The K-means method evaluates the distance between a sample and a reference point (centroid). This distance is evaluated for all the centroids, whose number is as much as the number of clusters. The closest centroid for a given sample determines the cluster which the given sample belongs to. The centroids are initially chosen randomly, while for each iteration they are evaluated as the mean value of the cluster, and the distances for each sample are evaluated again. The K-means method converges once no sample has changed its cluster.

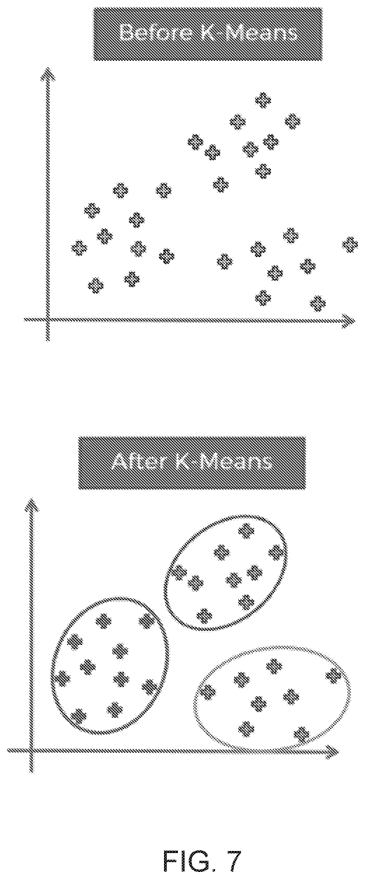

In this respect, FIGS. 6 and 7 show two examples of data clusters before and after K-means processing.

As the initial choice of the centroids is random, the K-means algorithm is performed N times (with N integer higher than zero, for example N=10) by evaluating, for each iteration, a metric (namely, Within-Cluster Sum of Squares−WCSS):

$$WCSS = {\sum }_{i = 1}^{cluster} {\sum }_{j = 1}^{sample} {( {x}_{ij} - {c}_{i} )}^{2}$$

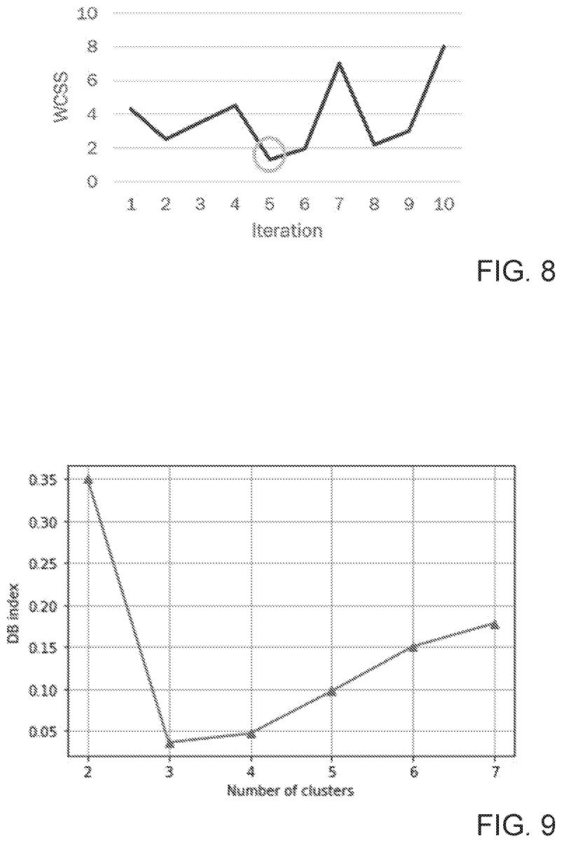

This metric simply evaluates the dispersion of data inside each cluster. Hence, the minimum value represents the best clustering for a given dataset and will be used for the following step (i.e., the Davies-Bouldin-Index-based evaluation step 422), as shown in FIG. 8 where the lowest WCSS corresponds to the 5th iteration that is, thence, chosen as the one to be used for the Davies-Bouldin-Index-based evaluation step 422.

In summary, in the K-means-based clustering step 421, q (number of clusters) centroids are chosen randomly (initialization). For each read data item, the distance from each centroid is evaluated. The shortest distance identifies the centroid for the i^{th} read data item. New centroids are chosen and new iteration(s) is/are performed until convergence occurs.

### 2.2 Davies-Bouldin Index

It is worth noting that the number of expected clusters q changes according to the considered truck. Therefore, the K-means algorithm is performed n times (with n integer higher than zero) by changing, for each iteration, the number of clusters (e.g., n=2, q=2,3).

In order to determine the best clustering for a given dataset, the Davies-Bouldin Index (DBI) is used. This metric simply evaluates the ratio between the intra-cluster dispersion and the inter-cluster separation:

$$DBI = maximum ( \frac{{s}_{i} + {s}_{j}}{{M}_{ij}} ) ,$$

where Sᵢ and Sⱼ denote the distance of cluster points from their centroids, and Mᵢⱼ denotes the distance between the i^{th} and the j^{th} centroids.

The minimum value of the DBI corresponds to the ideal number of clusters q_{Ideal}, as shown in FIG. 9 where the lowest value of the DBI is three and, hence, the ideal number of clusters is three (i.e., q_{Ideal}=3).

At this stage, the estimated tire configuration of the truck is extracted by counting the number of different UIDs for each cluster. For example, if one UID is detected in the first cluster, two UIDs are detected in the second cluster and three UIDs are detected in the third cluster, then the tire configuration of the truck will be 1-2-3 (i.e., one steering tire/wheel, two driving tires/wheels, three trailer tires/wheels).

### 2.3 Edit Distance

Then, in the Edit-Distance-based evaluation step 423, the estimated tire configuration is looked up in a given dictionary (which may be stored on the RFID reader 13 or on any other device connected to the RFID gate 1 in a wired or wireless fashion) containing several predefined trucks' tire configurations. It may happen that the estimated tire configuration does not correspond to any predefined one in the given dictionary: in this case, the estimated tire configuration is then compared to all the predefined tire configurations having the same overall number of tires. For each comparison, an Edit Distance metric is evaluated, which represents the number of operations required to transform the estimated tire configuration into the predefined one considered. The minimum Edit Distance determines the most probable tire configuration.

$$\{ \begin{matrix}Predefined tire configuration [ 1 , 2 , 3 ] \\ Estimated tire configuration [ 1 , 1 , 3 ]\end{matrix} \to Edit Distance = 3$$

$$\{ \begin{matrix}Predefined tire configuration [ 1 , 3 , 2 ] \\ Estimated tire configuration [ 1 , 1 , 3 ]\end{matrix} \to Edit Distance = 3$$

Therefore, the output of the Edit-Distance-based evaluation step 423 is the configuration of the tires/wheels of the truck and the number of axles (i.e. the number of UIDs for each cluster) for the truck's side with the highest number of read UIDs. Obviously, the same configuration can be considered also for the other truck's side.

In view of the foregoing, the clustering phase 42 exploits three statistical methodologies (namely, K-means, Davies-Bouldin Index and Edit Distance) jointly and synergistically in order to efficiently achieve the best clustering results.

### 2.4 Twin Tire Recognition

The twin tire recognition sub-step 424 is an optional step that is only performed if it is apparent, from the tire configuration identified at the end of the previous step, that twin tires are expected on the vehicle. Once the Edit-Distance-based evaluation step 423 has been performed, a threshold-based analysis of relative time distances among the read RFID tags is carried out to detect twin tires of dual-type wheels of the truck.

Conveniently, a truck-length-related time difference is computed between the first RFID tag read and the last one and each reading timestamp is normalized to the truck-length-related time difference computed. Then, for each UID, a respective median timestamp is determined and a respective relative time distance between said respective median timestamp and the median timestamps of the other read UIDs is computed. Thence, when a computed relative time distance is lower than a given threshold (e.g., equal to a given percentage of the truck-length-related time difference), twin tires are detected.

### 3. Sequencing

Once the clustering phase 42 has been carried out, the sequencing phase 43 is performed to correctly assign the UIDs to the actual tires.

Because the choice of the best side is based on the highest number of read RFID tags and because, at the end of the clustering phase, a tire configuration has been identified for all actual tires (even those for which there may be missing RFID readings), “missing tires” are not expected at this stage. Therefore, RFID tags' UIDs are assigned according to their cluster and their chronological position in it.

In the case where at least a twin tire configuration has been detected and sub-step 424 has been executed, it is also possible to particularly identify, within the twin tire configuration, which tire is in the inner position and which is in the outer position. In this case:
if there is at least one RFID reading for each tire in the twin tire configuration and the number of readings for one tire is different from the number of readings for the other tire, then it is assumed that the UID with the highest number of readings is associated to the outer tire and the UID with the lowest number to the inner tire: in fact, it is expected that the reading of the tag of the inner tire by the antennas 11, 12 is more prone to errors due to noise and interferences;
if there is at least one RFID reading with respect to one UID only, then it is assumed that said UID corresponds to the outer tire;
in the unlikely cases where (a) there are zero readings for both the tires of the twin tire configuration, or (b) the number of readings for each tire in the twin tire configuration is the same, then repeating the reading of the tags of the tires in the twin tire configuration may be needed.

Tire assignment on the other truck's side (i.e. the side corresponding to the data group on which the clustering phase has not been applied) can be split into two different cases:
all the expected RFID tags have been read: thence, read UIDs are assigned to tires according to time order of reading as previously described; or
there is at least one missing RFID tag: in this case, for each UID, the median timestamp is evaluated; then, the time distance between each timestamp related to the truck's side with fewer readings and the ones related to the other side is evaluated. In this way, tires on the truck's side with fewer readings are associated with the corresponding ones on the other side and the belonging cluster is determined; once the clusters have been determined, read UIDs are assigned to tires according to time order of reading as previously described.

In view of the foregoing, technical advantages and innovative features of the present invention are immediately clear to those skilled in the art.

In particular, it is worth noting that the tire identification method according to the present invention allows achieving excellent tire identification performance in terms of successful tire identifications and computational load. This enables the use of this lightweight and energy-efficient methodology even on low-performing processing devices.

As previously explained, the tire identification method according to the present invention is mainly based on three statistical methods, namely K-means, Davies-Bouldin Index and Edit Distance, wherein all these three statistical methods are known in the art, but the specific combined, sequential and synergistic use of them according to the present invention is not known at all in the art and brings significant benefits to overall performance of tire identification.

Moreover, the tire identification method according to the present invention allows identifying the configuration of a truck by using the arrangement of the axles. At the end of the process, a dictionary check is performed to look for a correlation with one known configuration in a predefined dictionary containing a-priori-identified configurations. This approach actually makes the methodology independent not only of the various types of trucks, but also of the type of motor vehicle itself. In fact, this method is also applicable to other types of vehicles, differently from known to methods that need fix a priori the type of structure/vehicle in order to exploit the a priori knowledge of the possible RFID tag position/geometry.

This concept is strengthened by the fact that the method according to the present invention uses only one dimension, i.e. time, which makes the algorithmic pipeline potentially adaptable to other acquisition systems other than those depending from the RFID and, hence, usable for new (even non-automotive) applications that require sequencing and identification of configurations.

In summary, the following strengths of the present invention can be highlighted:
1) the tire identification method can be considered lightweight thanks to its low computational burden, making the system effectively energy efficient;
2) the algorithm does not require a training phase: this makes the implementation of the present solution independent of the application context;
3) the system is customizable since the dictionary containing the list of truck's types can be created with predefined configurations; the algorithm will use the predefined configurations to find either an exact matching between the configuration found and an existing one, or to detect the most likely one based on an Edit-Distance-based comparison;
4) the system is robust with respect to the loss of some readings of RFID tags or of all readings of a specific RFID tag. The algorithm identifies the best side of the vehicle and uses it to search for the actual tire configuration; the determined tire configuration is then used for tire identification and positioning on the other truck's side. In any case, the Edit distance helps, with a good approximation, to identify the correct configurations even in cases of incorrect readings and/or noisy data;
5) only a time metric is used; this effectively makes the tire identification method independent from the RFID gate 1, because it becomes indifferent which technology or method is used to acquire the data;
6) any problem similar to that of identifying a truck configuration can potentially be solved by the present invention: as anticipated above, the proposed tire identification method is applicable to any type of vehicle, such as a train, a car or a bus.

In conclusion, it is clear that numerous modifications and variants can be made to the present invention, all falling within the scope of the invention, as defined in the appended claims.

To this respect, it is important to note that, even if in the foregoing the invention has been described by making specific reference to the use of RFID technology, it is absolutely clear to those skilled in the art that any other wireless identification technology can be used, such as, for example, a wireless identification technology of the Internet of Things (IOT) type.

Additionally, even if in the foregoing reference has been made to the specific example of tire tread wear monitoring, it is absolutely evident to those skilled in the art that the present invention can be advantageously exploited with any kind of tire feature monitoring (e.g., tire pressure monitoring, tire damage detection and monitoring, etc.).

1. Computer-implemented method for efficiently identifying tire configuration of motor vehicles having tires fitted, each, with a respective wireless identification device, the method comprising:
receiving identification data indicative of the unique identifiers of the tires positioned on a left side of a given motor vehicle of said motor vehicles;
receiving identification data indicative of the unique identifiers of the tires positioned on the right side of the given motor vehicle;
grouping the received identification data into a left-side data group and a right-side data group;
sorting the identification data in the left-side group and the identification data in the right-side group according to time order of acquisition;
for either the left-side group or the right-side group:
iteratively applying a K-means clustering method to the sorted identification data thereby obtaining, at each iteration, a respective identification data clustering representing a respective candidate tire configuration of the given motor vehicle;
evaluating the obtained identification data clusterings by a Davies-Bouldin Index metric thereby determining an estimated tire configuration of the given motor vehicle;
determining an actual tire configuration of the given motor vehicle by evaluating the estimated tire configuration by an Edit Distance metric;
determining a respective position, in the determined actual tire configuration, of each tire on the side associated to the determined group and assigning to said position the respective unique identifier based on said determined actual tire configuration and on the sorted identification data;
determining a respective position, in the determined actual tire configuration, of each tire on the opposite side of the given motor vehicle and assigning to said position the respective unique identifier based on said determined actual tire configuration and on the sorted identification data.

2. The method of claim 1, wherein the actual tire configuration of the given motor vehicle is determined based on a given dictionary of predefined tire configurations.

3. The method of claim 2, wherein the actual tire configuration of the given motor vehicle is determined by looking up the estimated tire configuration in the given dictionary, and wherein:
if the estimated tire configuration corresponds to a given predefined tire configuration among said predefined tire configurations, it is determined that the actual tire configuration is said given predefined tire configuration; whereas
if the estimated tire configuration does not match any of the predefined tire configurations, a respective Edit Distance is computed between the estimated tire configuration and each predefined tire configuration in the given dictionary, whereby the actual tire configuration is the predefined tire configuration with the lowest Edit Distance from the estimated tire configuration.

4. The method according to claim 1, wherein the respective position, in the determined actual tire configuration, of each tire on the opposite side of the given motor vehicle is determined and the respective unique identifier is assigned to said position based also on the determined positions, in said determined actual tire configuration, of the tires on the side associated to the determined group.

5. The method according to claim 1, further including performing a threshold-based analysis of relative time distances among the sorted identification data to detect twin tires of dual wheels of the given motor vehicle.

6. The method according to claim 1, wherein the given motor vehicle is a truck, a semitruck, a road train, a car, a bus or the like.

7. Tire identification gate designed to be driven through by, and to identify tires of, motor vehicles having tires fitted, each, with a respective wireless identification device, the tire identification gate comprising at least two antennas and a reader;
wherein the antennas are:
arranged on opposite sides of a path to be driven by the motor vehicles passing through the tire identification gate; and
configured, while a given motor vehicle of said motor vehicles is driving through the tire identification gate, to acquire from the respective wireless identification device of each tire of said given motor vehicle respective identification data indicative of a respective unique identifier of said tire;
wherein the reader is configured to carry out the method as claimed in claim 1.

8. The tire identification gate of claim 7, further comprising a tire monitoring system configured, while the given motor vehicle is driving through the tire identification gate, to monitor one or more tire features;
wherein each identified tire is associated with respective tire monitoring data provided by the monitoring system and related to said identified tire.

9. Tire identification method comprising:
a) providing a tire identification gate to be driven through by motor vehicles having tires fitted, each, with a respective wireless identification device, wherein said tire identification gate comprises
at least two antennas arranged on opposite sides of a path to be driven by the motor vehicles passing through the tire identification gate, and
a reader;
b) acquiring, while a given motor vehicle of said motor vehicles is driving through the tire identification gate, by the antennas from the respective wireless identification device of each tire of said given motor vehicle, respective identification data indicative of a respective unique identifier of said tire;
c) carrying out, by the reader, the method as claimed in claim 1.

10. The tire identification method of claim 9, wherein the tire identification gate further comprises a tire monitoring system, and wherein the tire identification method further includes:
monitoring, by the tire monitoring system, while the given motor vehicle is driving through the tire identification gate, one or more tire features; and
associating each identified tire with respective tire monitoring data provided by the monitoring system and related to said identified tire.

11. Computer program comprising instructions which, when the program is executed by a computer, cause the computer to carry out the method of claim 1.

12. A computer-readable storage medium comprising instructions which, when executed by a computer, cause the computer to carry out the method of claim 1.

13. Software or firmware product comprising software/firmware code portions that are:
loadable/storable on, and executable by, a reader of a tire identification gate that is designed to be driven through by motor vehicles having tires fitted, each, with a respective wireless identification device, and that comprises also at least two antennas arranged on opposite sides of a path to be driven by the motor vehicles passing through the tire identification gate, wherein said antennas are configured to
acquire, while a given motor vehicle of said motor vehicles is driving through the tire identification gate, from the respective wireless identification device of each tire of said given motor vehicle, respective identification data indicative of a respective unique identifier of said tire, and
provide the reader with the acquired identification data; and
such to cause, when executed by the reader, said reader to carry out the method claimed in claim 1.
